(19) United States
(12) Patent Application Publication
(10) Pub. No.: US 2010/0028585 A1
(43) Pub. Date: Feb. 4, 2010

(54) LAMINATED GLASS, WINDOW MATERIAL, AND WALL SURFACE STRUCTURES WITH WINDOWS

(76) Inventor: Narutoshi Shimatani, Shiga (JP)

Correspondence Address: WENDEROTH, LIND & PONACK, L.L.P., 1030 15th Street, N.W.,, Suite 400 East, Washington, DC, 20005-1503, US

(21) Appl. No.: 12/528,507

(22) PCT Filed: May 29, 2008
(86) PCT No.: PCT/JP2008/059873

§ 371 Date: Aug. 25, 2009

(30) Foreign Application Priority Data
Jun. 1, 2007 (JP) 2007-146533

(51) Int. Cl. B32B 17/10; B60J 1/00

(52) U.S. Cl. 428/38; 428/215

(57) ABSTRACT

A laminated glass which is constituted of seven glass layers each formed of a 0.7 mm thick glass sheet and resin layers interposed between the glass layers respectively which resin layers are made of polyvinyl butyral (PVB) resin and have each a thickness of 0.5 mm with the total number of the glass layers and the resin layers being 13. Between a glass layer and a resin layer which are adjacent to each other, the thickness ratio of the resin layer to the glass layer (11) (the ratio of the thickness of the resin layer and the thickness of the glass layer) is 0.71. A base material resin constituting the resin layers may be ethylene/vinyl acetate copolymer (EVA) or methacrylic resin (PMA) as well as polyvinyl butyral (PVB) resin.

### TECHNICAL FIELD

The present invention relates to a laminated glass having shock absorbing ability, which is preferred as a window material, mainly for, buildings, automobiles, and railroad vehicles.

### BACKGROUND ART

A layered glass body generally called a laminated glass, in which an intermediate layer is interposed between two sheet glasses, is used for satisfying the request for performance that cannot be realized with a structure simply made of glass. Examples of the use of such a laminated glass include a structural member such as a wall and a floor surface requiring transparency, a window material requiring high mechanical durability, and a window material with high heat insulation and heat resistance. The laminated glass is also used as an electronic device member for displaying an image such as a liquid crystal display, in addition to the above-mentioned uses. Currently, the use of the glass laminated structure is diversified, and the production or products thereof require a high technology in most cases. Therefore, in order to satisfy various demands, a number of inventions have been carried out for the laminated glass.

For example, Patent Document 1 discloses a laminated glass which is bonded with at least one intermediate film made of a synthetic resin composition, with the thicknesses of front and back sheet glasses being different and the difference in thickness being 1 mm or more.

Further, Patent Document 2 discloses a coating transparent body in which glass is placed on one surface and a shock resistant transparent plastic is placed on the other surface and configured integrally.

Further, Patent Document 3 discloses a laminated glass with a resin inserted therein, in which an intermediate layer made of a sheet of polyethyleneterephthalate and a transparent resin exhibiting pressure-sensitive adhesion by heat melting is inserted between a pair of sheet glasses and the sheet glasses are integrated by bonding.

### Patent Document 1: JP 2001-39743 A

### Patent Document 2: JP 2001-18326 A

### Patent Document 3: JP 2002-321948 A

### DISCLOSURE OF THE INVENTION

### Problem to be Solved by the Invention

The conventional laminated glass does not have sufficient penetration resistance with respect to impact applied repeatedly and concentratively with concentration, for example, in the case where impact is applied repeatedly and concentratively to one point of a glass surface with a sharp tool with concentration.

Further, the laminated glass is also used as safety glass, and it is necessary to consider the influence by various factors involving a number of problems such as the increase in aged generations and the decrease in number of family members, caused by the recent change in a social structure. In particular, when an aged person is living alone, the housing space thereof requires high safety. Therefore, it is expected in the future that there is an increasing demand for a laminated glass capable of realizing higher safety and higher reliability.

A reinforced glass such as tempered glass is generally considered to have high strength. However, such a reinforced glass does not necessarily have sufficient strength against impact applied repeatedly and concentratively as described above. When the stress balance in the reinforced glass is once lost due to an external force which may stick a small region on the surface, the reinforced glass may be completely collapsed immediately due to the release of an internal stress. Further, a so-called wired glass cannot be expected to have a large resistance against crimes such as sneak-in and break-in. The wired glass has a visual effect for crime prevention due to the presence of a wire. However, regarding an external force required for breaking, there is no substantial difference between the wired glass and an ordinary window sheet glass. As measures for enhancing durability with respect to the repeated and concentrated impacts at one point, there is a method of simply enlarging the thickness of a glass sheet. In that method, although the durability is enhanced to some extent, the weight of a window material becomes very large. In this case, a special window frame is required, which makes the construction difficult, and also which makes the open/close operation of the window difficult.

An object of the present invention is to provide a laminated glass which has high penetration resistance and impact resistance with respect to impact applied to one point on the surface of glass repeatedly and concentratively, which is lightweight to such a degree as not to have a structural burden and is economically advantageous, and which is excellent in shock absorbing ability suitable for the use as in various kinds of buildings and vehicles, and a window material and a wall surface structure with a window using the laminated glass.

### Means for Solving the Problems

Specifically, a laminated glass of the present invention is a laminated glass including glass layers and resin layers laminated with each other, characterized in that a lamination structure in which four or more layers including the glass layers with a thickness of 1 mm or less and the resin layers with a thickness of 1 mm or less are laminated alternately, and a ratio of a thickness of the resin layer adjacent to the glass layer in the lamination structure against a thickness of the glass layer is in a range of 0.1 to 2.0.

The laminated glass of the present invention may be constituted by the above-mentioned laminated structure as a whole or may contain the above-mentioned laminated structure partially. In the latter case, generally, one of the front and back transparent surfaces of the laminated glass is formed of a glass layer of the above-mentioned laminated structure and the other of the transparent surfaces is formed of a glass layer or a resin layer other than the above-mentioned laminated structure. Or alternatively, both the front and back transparent surfaces are formed of a glass layer other than the above-mentioned laminated structure, and the laminated structure is positioned at a predetermined depth from the front and back transparent surfaces. Or alternatively, both the front and back transparent surfaces are formed of a glass layer of the above-mentioned laminated structure, and a resin layer and/or a glass layer other than the laminated structure is inserted in the above-mentioned laminated structure. Further, the laminated glass of the present invention may include two or more laminated structures. In any of the above-mentioned structures, the laminated glass of the present invention has a shock absorbing structure described later on the surface or inside thereof when receiving shock at the same point of the transparent surface, the shock absorbing structure contributing to the enhancement of the shock resistance and penetration resistance of the laminated glass. In order to allow the function of such a shock absorbing structure to be exhibited more effectively, the above-mentioned laminated structure is provided preferably close to the transparent surface of the laminated glass to which impact is applied, and more preferably, the transparent surface of the laminated glass to which impact is applied is formed of a glass layer of the above-mentioned laminated structure.

In the case where the laminated glass of the present invention includes the above-mentioned laminated structure partially, a portion other than the above-mentioned laminated structure can be formed without specifying mode and material. For example, the thickness of the resin layer or the glass layer constituting the portion other than the above-mentioned laminated structure may be 1 mm or more, or two kinds of resin layers may be adjacent to each other. Further, it is not necessary that the portion other than the laminated structure is bonded to the laminated structure, and a space with a predetermined thickness may be provided therebetween.

The glass layer may contain an inorganic glass material. The glass layer may contain crystal, ceramics, metal, air bubbles, and the like in appropriate amounts in addition to the inorganic glass. For example, the glass layer may be constituted by a sheet of crystallized glass (which may be also called glass ceramics), for example, instead of being constituted by a sheet of glass.

The above-mentioned resin layer may be constituted by a material containing a resin. The resin layer may be formed using a resin material in a sheet shape or a film shape or formed by solidifying a liquid-like or paste-like resin material. Further, the resin layer may contain other kinds of resins, metal, glass, carbon, crystal, and the like in addition to the base material resin. It should be noted that the content of the base material resin of the resin layer is preferably 60% or more in a mass percentage. Further, when the laminated glass of the present invention is used as a lighting window for buildings and vehicles, the resin layer as well as the glass layer require transparency to visible light. Thus, other contained components in addition to the base material resin require the property that does not remarkably impair the transparency to visible light. Further, the concentration the base material resin and the other contained components may be distributed uniformly or not. For example, one component of such mixed material can be distributed in a large amount in a region close to an outer periphery of the transparent surface of the laminated glass.

Further, the thickness of the glass layer and the resin layer in the above-mentioned laminated structure is 1 mm or less. When the thickness of each layer is too small, it is necessary to laminate a large number of layers so as to realize stable performance, which may increase the production cost of the laminated glass. Therefore, in the glass layer, the thickness is set to be preferably 0.05 mm or more, more preferably 0.1 mm or more, and further preferably 0.2 mm or more. Regarding the resin layer, the thickness thereof is set to be preferably 0.01 mm or more, more preferably 0.05 mm or more, and further preferably 0.1 mm or more.

The inventors of the present invention earnestly studied so as to obtain a laminated glass with a structure capable of withstanding the penetration for a sufficiently long period of time, even under the strict conditions in which impact is applied to one point of the transparent surface (in one region having an area of 10% or less of the entire area of the transparent surface) repeatedly and concentratively. As a result, the inventors found that, by allowing the laminated glass to have a particular condition in laminated structure as a whole or partially, the effect of alleviating the above-mentioned shock is obtained, and high penetration resistance and shock resistance are obtained. More specifically, in the laminated structure of the present invention, when impact is applied to one point of the surface thereof repeatedly, fine glass powder generated by the impact-induced fracture of a glass layer is kneaded with a resin of an adjacent resin layer to come into contact therewith to form a mixture due to a strong external force caused by the impact, and the mixture functions as a shock absorber by virtue of the structure. The mixture with such a shock absorbing structure is formed immediately under a site of the transparent surface to which the shock is applied or in the vicinity thereof.

As described above, the first structural feature of the laminated structure of the present invention is that the thicknesses of the glass layer and the resin layer laminated alternately are respectively 1 mm or less, and the number of layers is 4 or more. With such a configuration, the shock absorbing structure is likely to be generated by repeated impacts. Further, even in the case where the thickness of the entire laminated structure is relatively small and light-weight, and exhibits flexibility, high penetration resistance and high shock resistance are obtained.

Further, the second structural feature of the laminated structure of the present invention is that the ratio of the thickness of the glass layer and the thickness of the resin layer in contact with the glass layer (thickness of resin layer/thickness of glass layer) is in a range of 0.1 to 2.0. With such a configuration, the above-mentioned shock absorbing structure is formed exactly, the sufficient effect to penetration resistance and the like is obtained, and the adhesive strength of the resin layer against the glass layer can be sufficiently obtained.

In the laminated glass of the present invention, the surface of the glass layer constituting the transparent surface of the front surface and/or the back surface may be coated by a film, if required. Regarding the kind of the film that can coat the surface, those for changing optical performance, those for changing the hardness of the surface, those for adjusting and altering the conductivity and the moisture resistance appropriately can be selected.

As a film for coating the surface, for example, there can be used a material having a composition of silica (SiO₂), alumina (Al₂O₃), zirconia (ZrO₂), tantalum oxide (or tantala) (Ta₂OS), niobium oxide (Nb₂O₅), lanthanum oxide (La₂O₃), yttrium oxide (Y₂O₃), magnesium oxide (MgO), hafnium oxide (HfO₂), chromium oxide (Cr₂O₃), magnesium fluoride (MgF₂), molybdenum oxide (MoO₃), tungsten oxide (WO₃), cerium oxide (CeO₂), vanadium oxide (VO₂), titanium zirconium oxide (ZrTiO₄), zinc sulfide (ZnS), cryolite (Na₃AlF₆), chiolite (Na₅Al₃F₁₄), yttrium fluoride (YF₃), calcium fluoride (CaF₂), aluminum fluoride (AlF₃), barium fluoride (BaF₂), lithium fluoride (LiF), lanthanum fluoride (LaF₃), gadolinium fluoride (GdF₃), dysprosium fluoride (DyF₃), lead fluoride (PbF₃), strontium fluoride (SrF₂), an antimony-containing tin oxide (ATO) film, an indium oxide-tin film (ITO film), a multilayer film of SiO₂ and Al₂O₃, an SiOx-TiOx-based multilayer film, an SiO₂-Ta₂O₅-based multilayer film, an SiOx-LaOx-TiOx-based multilayer film, an In₂O₃—Y₂O₃ solid solution membrane, an alumina solid solution membrane, a metal thin film, a colloid particle-dispersed film, a polymethyl methacrylate film (PMMA film), a polycarbonate film (PC membrane), a polystyrene film, a methyl methacrylate-styrene copolymer film, a polyacrylate film, and the like.

As a method of forming the coating film, various methods can be employed as long as a desired surface state and function can be realized and the required cost can be acceptable. For example, a sputtering method, chemical vapor deposition methods (or CVD methods) such as a vacuum vapor deposition method, a thermal CVD method, a laser CVD method, a plasma CVD method, a molecular beam epitaxy method (MBE method), an ion plating method, a laser abrasion method, and a metalorganic chemical vapor deposition method (MOCVD), and liquid phase growth methods such as a sol-gel method, a spin coating method, a coating method of a screen printing, and a plating method can be employed. Of those, the CVD method is particularly preferred because the CVD method enables a coating with good adhesion at a low temperature and is applicable to various coating films such as compound films.

Further, it is preferred that, in the laminated glass of the present invention, the base material resin of the resin layer constituting the laminated structure be a thermoplastic resin. Since the thermoplastic resin has various properties depending upon the material, various properties of the laminated glass such as mechanical strength and light transmittance can be adjusted by selecting an appropriate thermoplastic resin depending upon the use.

As the thermoplastic resin, for example, there can be used polypropylene (PP), polystyrene (PS), polyethylene (PE), polybutylene terephthalate (PBT), cellulose acetate (CA), a diallyl phthalate resin (DAP), an ethylene-vinyl acetate copolymer (EVA) a methacrylic resin (PMA), polyvinyl chloride (PVC), polyethylene terephthalate (PET), a urea resin (UP), a melamine resin (MF), an unsaturated polyester (UP), polyvinyl butyral (PVB), polyvinyl formal (PVF), polyvinyl alcohol (PVAL), a vinyl acetate resin (PVAc), an ionomer (IO), polymethyl pentene (TPX), vinylidene chloride (PVDC), polysulfone (PSF), polyvinylidene fluoride (PVDF), a methacryl-styrene copolymer resin (MS), polyarylate (PAR), polyarylsulfone (PASF), polybutadiene (BR), polyether sulfone (PESF), or polyether ether ketone (PEEK)

It is required that the resin material applied to the above-mentioned resin layer has properties of being easily mixed with fine glass powder under receiving impact and being easily bonded to a sheet glass (glass layer). In terms of such properties, the thermoplastic resin is useful, and a vinyl-based resin is generally preferred. Of those, polyvinyl butyral (PVB) and an ethylene-vinyl acetate copolymer (EVA) are suitable as the base material of the above-mentioned resin layer. The reasons for this are related to the fact that those resin materials are appropriately soft and have high adhesiveness with respect to a glass material.

The formation of the above-mentioned shock absorbing structure is related to the softness of a resin at a room temperature (about 25° C.) and the adhesiveness to glass. In addition, the softening of a resin due to the heat generated by impact and the increase in adhesiveness also influence that formation. When impact is given, the impact energy is partly converted into heat, and the temperatures increase at the tip of a impact material and at the impact-rendered area. Due to the increase in temperature, the softening of the thermoplastic resin proceeds and the adhesiveness to glass also increases. The changes in resin characteristics accelerate the impact-induced mechanical mixing of fine glass powder with a resin to form a mixture densely kneaded. Further, the degree of temperature increase by impact is several ° C. to tens of ° C. although it depends upon how impact force is applied or repeated. The temperature increase in such a range will decrease viscosity of thermoplastic resin. As a result, that temperature increase heightens the adhesiveness to a sheet glass (glass layer) and contributes to the kneading formation of a shock absorbing substance.

On the other hand, in a hard resin such as polycarbonate and polyimide resin, the shock absorbing structure is unlikely to be formed due to insufficient softness and adhesiveness of a resin. Even if the temperature increases to some degree due to the impact-induced heat, the decrease in viscosity and the increase in adhesiveness is not enough to accelerate the formation of the shock absorbing structure.

Regarding a glass material, generally, fine powder is formed in a area broken by impact when the glass material is served as a thin sheet with a thickness of 1 mm or less regardless of the glass composition and structure.

When impact is applied repeatedly and concentratively to one point on a transparent surface (in one region having an area of 10% or less with respect to the total area of the transparent surface), and two or more glass layers constituting the laminated structure is broken to form the above-mentioned shock absorbing structure, the shock absorbing body preferably includes at least 5 glass particles of 0.5 mm or less generated by the crushing of a glass layer per 30 mm³ volume in order to ensure high penetration resistance and shock resistance.

When the above-mentioned shock force is applied, the glass layer is broken to form a new surface such as cracks. A part of the broken glass layer is dissociated from the original glass layer to become glass particles. Then, the glass particles are buried in the adjacent resin layer to be mixed therewith to form a shock absorbing structure. The total volume of the shock absorbing structure is preferably 1/10 or less of the entire volume of the laminated glass.

Hereinafter, a method of repetitive one-point-impact test and the testing device are described. FIG. 3 illustrates a schematic configuration of a test device. In the device figure of FIG. 3, part (A) represents a front view, part (B) represents a side view, 10a denotes a laminated glass, 20 denotes a ceiling support member, 21 denotes a side surface support member, 22 denotes a wire member, 23 denotes a front surface frame for fixing a laminated glass, 24 denotes a frame fixing rivet, 25 denotes a sample holding platform, 26 denotes a back surface frame for fixing a laminated glass, 27 denotes a frame protecting ceiling plate, 28 denotes a frame protecting side surface plate, K denotes a head portion weight, L denotes a head portion upswing height, P denotes a head portion pendulum radius, and W denotes a wire fixing distance. In this test, the laminated glass 10a is sandwiched between the front surface frame 23 and the back surface frame 26 so as to be fixed at four corners on the periphery thereof, and fixed with the frame fixing rivet 24. Further, the laminated glass 10a is supported with the sample holding platform 25 so that a glass transparent surface thereof is perpendicular to the ground surface. The head portion is fixed to the ceiling support member 20 with two wire members 22 at each end side. When the head portion is allowed to fall, a tip end H of the head portion takes an arc path to collide a predetermined region of the glass transparent surface of the laminated glass 10a. By allowing the head portion to fall repeatedly, impact can be applied to one point on the glass transparent surface repeatedly.

As the frames 23, 26 for fixing the laminated glass 10a, not a soft wood such as a cork material but a hard wood such as an oak material are used. When the frames 23, 26 come into direct contact with the laminated glass 10a, a stress is concentrated on the contact portion, which may cause cracks. Therefore, a butyl rubber sheet with a thickness of 3 mm is placed at the contact site between the frames 23, 26 and the glass 10a. This can prevent the impact force from concentrating at a given local site of the frames. The external sizes of the frames 23, 26 are an inner dimension: 70×570 mm and an outer dimension: 800×730 mm. The laminated glass 10a used for the impact test may have a transparent glass surface larger than the inner dimensions of the frames 23, 26. As the wires 22, two stainless wires with a length P of 193 cm are used. The fixing distance W of the wire members 22 fixed tightly to two points of the ceiling support member 20 is 1450 mm. The frame for fixing the laminated glass 10a needs to have a sturdy structure. Therefore, a box-shaped structure is formed of the frame protecting ceiling plate 27 and the frame protecting side surface plate 28 so that the test can be conducted safely even if glass scatters.

The impact object is made of steel and the mass thereof is 6.1 kg. The head part is a cone H which is 450 mm long and round shaped at the tip end with radius 3 mm. The cone H is attached to the cylinder K with screw joint. The impact object is hung above the laminated glass 10a with two wires 22 fixed to two different points on the ceiling surface. The reason why the two wires 22 are used is to prevent a displacement in a lateral direction with respect to the impact position when the head of the impact object collide the glass surface. In the impact test, after the impact object is raised to an initial position so that an upswing height L is 700 mm or 1400 mm, that is released to fall. As a result, the tip end H with a radius of 3 mm takes an arc path from above to collide a desired area of the laminated glass. By conducting such an operation repeatedly, the durability of the laminated glass against the repetitive one-point-impact can be evaluated.

In the impact test, the upswing height L of the impact object refers to the height difference between the horizontal position of the impact object when that collides the glass transparent surface and the horizontal position of the head portion raised away from the glass surface with the wires fully stretched. In this test, the difference in height is set to be 700 mm or 1400 mm. Further, in this test, in order to prevent the tip end H of the impact object from bouncing on the glass surface and hitting that again in a single release, a system to prevent a repeated collision is provided (not shown). Owing to the system, in this test, the number of impacts can be measured accurately.

Regarding the test environment of the impact test, the impact test is usually conducted in the atmosphere at room temperature the humidity should be controlled at 80% or less. When the humidity is higher than 80%, the humidity may influence the break-susceptibility of glass, when appropriate evaluation cannot be expected for the test body. However, in a case to evaluate samples under special conditions such a high temperature and a humid atmosphere, the testing atmosphere may be adjusted accordingly. Further, the surface subjected to impact may be usually observed with naked eyes. In case of a delicate evaluation, a stereo microscope, a photographing recording device, and the like may be used together.

According to the evaluation by such a very severe impact test, the tip H of the impact object easily penetrates all the layers of the existing laminated glass. On the other hand, the tip H does not easily penetrate the layers of the laminated glass 10a of the present invention. Therefore, even if an attempt is made to break the laminated glass by applying an impact to the same area of the glass transparent surface repeatedly, using a sharp tool such as a hammer and a bar, two or more glass sheets is not broken easily and all the layers of the laminated glass are not penetrated unlike the conventional example. The laminated glass of the present invention can exhibit high performance with respect to crime prevention due to such a resistance for breakage.

In order to grasp a detailed structure, a composition, and the like regarding the shock absorbing structure formed on the glass transparent surface by repetitive one-point impacts, a conventional analysis or measurement can be used. For example, by appropriately using an SEM, ion chromatography, an IPC light-emission analysis device, an image analysis device, a stereoscopic microscope, an X-ray fluorescence analysis device, an elasticity measurement device, a viscoelasticity measurement device, and the like, the composition and characteristics of a shock absorbing body can be specified.

The window material of the present invention is characterized in that a protective member is placed on at least one of the end surface of the laminated glass and the peripheral area of the front and back transparent surfaces.

One of the objects of placing the above-mentioned protective member is to protect the end surface and the peripheral area from damages caused by bumping during the transportation and construction of the laminated glass. Further, the second object of placing the protective member is to prevent the resin layer from being denatured, and the third object is to prevent the detachment of each joint layer due to the decrease in adhesion at an interface.

Further, the window material of the present invention can protect the end surface and the peripheral area of the transparent surface exactly as long as the protective member is formed of a plate shape, a net shape, a film shape, a paste shape, a cloth shape, a particle shape, an annular shape, and a band shape in addition to the above, and an optimum material configuration can be selected depending upon the use.

The window material of the present invention may have a through-hole for attaching a handle or the like to an appropriate area of the transparent surface. Further, a bottomed hole extending to some midpoint in a depth direction may be provided instead of the through-hole. The surface of the transparent surface may be sculpted or patterned to be uneven. As the uneven pattern, those which are formed using film attachment, laser processing, press molding, or the like can be adopted.

The wall surface structure with a window of the present invention are characterized in that the window material mentioned above is placed as a lighting window or a monitoring window.

The lighting window or the monitoring window can be used as a window material specifically in various housing constructions such as a condominium and a house, and various public constructions such as a library, a museum, a public bathroom, a school, a police station, and a city hall. The lighting window or the monitoring window can also be used in constructions where a number of people gather, such as a large store, an exhibition hall, and a movie theater. Further, the lighting window or the monitoring window can also be used as a transmission shielding structure material such as a showcase material and an indoor display that contain and exhibit valuables, and a partition material, a security protection material, and the like in play facilities. Further, the lighting window or the monitoring window can also be used as a control monitoring window in various kinds of experiment facilities, a monitoring window in a hospital and a nursing-care facility, and a lighting window or a partition window for monitoring in a culture facility such as a zoo and a botanical garden.

### EFFECTS OF THE INVENTION

Due to the above-mentioned configuration, the laminated glass of the present invention can realize high penetration resistance and excellent shock resistance, and realize a structure that is light to such a degree as not to give a burden structurally, even in the case where a impact force is applied to one point of a transparent surface repeatedly and concentratively.

### BEST MODE FOR CARRYING OUT THE INVENTION

Hereinafter, the laminated glass of the present invention, the window material using the laminated glass, and further, the wall surface structure with a window provided with the window material are specifically described in detail.

### Example 1

FIG. 1 illustrates a partial cross-sectional view of the laminated glass of the present invention. A laminated glass 10 of this example has a configuration in which 7 thin sheet glasses with a thickness of 0.7 mm are laminated as glass layers 11, each sheet glass being composed of alkali-free borosilicate glass containing 45 to 74% of SiO₂, 2 to 24% of B₂O₃, and 4 to 30% of RO (RO═MgO+Cao+ZnO+SrO+BaO) by mass percentage in terms of oxides, and polyvinyl butyral (PVB) resins with a thickness of 0.5 mm are interposed as resin layers 12 between the respective glass layers 11. Thus, the laminated glass 10 is a laminate of 13 layers in total including the glass layers 11 and the resin layers 12. In the glass layers 11 and the resin layers 12 adjacent to each other, the ratio of the thickness of the resin layers 12 with respect to the thickness of the glass layers 11 (thickness of the resin layers 12/thickness of the glass layers 11) is 0.71. The laminated glass 10 has a configuration in which 7 thin sheet glasses with a thickness of 0.7 mm are laminated as glass layers 11 and polyvinyl butyral (PVB) resins with a thickness of 0.5 mm are interposed as resin layers 12 between the respective glass layers 11, and thus, the laminated glass 10 is a laminate of 13 layers in total including the glass layers 11 and the resin layers 12. In the glass layers 11 and the resin layers 12 adjacent to each other, the ratio of the thickness of the resin layers 12 with respect to the thickness of the glass layers 11 (thickness of the resin layers 12/thickness of the glass layers 11) is 0.71.

Further, in this example, though a polyvinyl butyral (PVB) resin is used as a base material resin of the resin layer 12, an ethylene vinyl acetate copolymer (EVA) or a methacrylic resin (PMA) may be used instead.

An exemplary use of the laminated glass 10 includes the application to a portion in which lighting is required in a semibasement room of a house having a semibasement structure. When the laminated glass 10 is used as a window material constituting a part of a ceiling member of a wall surface structure with a window, large effect on lighting is obtained, and the window material is not easily penetrated even when impact is applied, whereby safety can be ensured.

The laminated glass 10 can be produced as follows. First, a predetermined number of clean thin sheet glasses with a predetermined size forming the glass layers 11 are prepared. Then, a predetermined number of film-shaped or sheet-shaped resin materials with a predetermined size made of a resin material forming the resin layers 12, for example, the above-mentioned resin are prepared. Then, the resin materials are interposed between the thin sheet glasses to form a layered structure, which is processed with heat-press to finish the lamination. Herein, though the heat pressure bonding method is adopted, another method may be applied, if required.

In order to form the laminated glass 10 into a window material capable of being applied to a part of a ceiling member of the wall surface structure with a window as described above, a protective structure as illustrated in FIG. 2 was placed. Herein, a band-shaped sheet 15 with a width of 7.9 mm corresponding to the width of an end surface of the laminated glass 10 and a thickness of 0.5 mm was attached as a protective member to a part of four flat end surfaces of the laminated glass 10. The material for the band-shaped sheet 15 is a transparent polyethylene sheet material 15. The band-shaped sheet 15 was bonded to the end surfaces of the laminated glass 10 by applying a pressure-sensitive adhesive to one surface of the sheet 15 and attaching the surface to the end surfaces of the laminated glass 10. Such a structure can efficiently prevent development of scratch even if the end surfaces are rubbed against the wall surface during attachment. Further, stable strength performance can be realized over a long period of time after the application. The external dimensions of a transparent surface of the window material are 1,000 mm wide and 1,500 mm long, and the total thickness of the window material is 7.9 mm. Then, corner portions of the transparent surface of the window material are processed to round surface working at a radius of 40 mm.

In this example, the band-shaped sheet material 15 of transparent polyethylene is used as the protective member. However, another material may be used. For example, a configuration in which a cloth-shaped sheet or a net-shaped sheet plain-woven with glass fibers are bonded to the end surfaces can be adopted. Further, a silicon resin agent in a paste form may be applied to the end surfaces to form a buffer layer. Further carbon particles of glassy carbon composite may be applied to the end surfaces, or a thick plate with a thickness of 2.0 mm made of polypropylene may be bonded to the end surfaces. In the bonding operation of those protective members, an appropriate pressure-sensitive adhesive may be applied previously to a protective member, or the protective member is coated or impregnated with the pressure-sensitive adhesive, whereby the operation can be simplified. At this time, the end surfaces also may be applied with the pressure-sensitive adhesive. Further, processing such as heat-press bonding may be used.

### Example 2

Next, the laminated glass of the present invention and laminated glasses of comparative examples are described regarding a repetitive one-point-impact test conducted so as to evaluate shock absorbing ability.

First, as a sheet glass for forming a laminated glass used for a repetitive one-point-impact test, alkali-free glass (glass code OA-10) manufactured by Nippon Electric Glass Co., Ltd. was formed by a downdraw molding method to a thickness of 0.7 mm. The sheet glass of OA-10 thus obtained was cut to 750 mm×620 mm to prepare a predetermined number of sheet glasses. Then, a predetermined number of resin materials in a film shape with a predetermined thickness made of an ethylene vinyl acetate copolymer (EVA) or polyvinylbutyral (PVB) were prepared. The film-shaped resin materials were interposed between the respective sheet glasses, and the heat-press was carried out to finish the lamination.

The laminated glass obtained in the above-mentioned procedure was attached to the testing device as described above (see FIG. 3) for evaluation. The configuration of the testing device and the test method are as described above. Herein, after every impact from releasing an impact object, whether or not the head portion penetrates all the layers of the laminated glass at each time is checked with observation. According to the above-mentioned procedure, the laminated glass of the present invention was evaluated as examples, and commercially available laminated glasses that have been used conventionally were used as comparative examples for evaluation. Table 1 summarizes those results.

TABLE 1

| Sample No. | | | Example | | | | | Comparative Example | | | | |
|---|---|---|---|---|---|---|---|---|---|---|---|---|
| | | | 1 | 2 | 3 | 4 | 101 | 102 | 103 | 104 | 105 | |
| Laminate | Sheet-shaped layer | Material | OA-10 | OA-10 | OA-10 | OA-10 | Soda | Soda | Soda | Soda | Re- | Soda |
| structure | having composition | | | | | | sheet | sheet | sheet | sheet | inforced | sheet |
| | containing glass | | | | | | | | | | glass | |
| | | Thickness of | 0.7 | 0.7 | 0.7 | 0.7 | 3.0 | 3.0 | 3.0 | 3.0 | 8.0 | 3.0 |
| | | one sheet | | | | | | | | | | |
| | | (mm) | | | | | | | | | | |
| | | Number of | 6 | 8 | 8 | 6 | 2 | 2 | 2 | 2 | 1 | 1 |
| | | layers | | | | | | | | | | |

| | | | | | | | | | | |
|---|---|---|---|---|---|---|---|---|---|---|
| Sheet-shaped layer | Material for | PVB | EVA | PVB | PVB | — | PVB | PVB | PC | PVB |
| containing resin as | resin layer | | | | | | | | | |
| main component | Thickness of | 0.8 | 0.3 | 0.8 | 0.4 | — | 1.5 | 2.3 | 1.2 | 2.3 |
| | one sheet | | | | | | | | | |
| | (mm) | | | | | | | | | |
| | Number of | 5 | 7 | 7 | 5 | — | 1 | 1 | 1 | 1 |
| | layers | | | | | | | | | |

| | Ratio of adjacent (thickness of | | 1.14 | | 0.43 | 1.14 | 0.57 | — | 0.50 | 0.77 | 0.40 | 0.29 | 0.77 |
|---|---|---|---|---|---|---|---|---|---|---|---|---|---|
| | sheet-shaped layer of resin main | | | | | | | | | | | | |
| | component/thickness of sheet- | | | | | | | | | | | | |
| | shaped layer of glass phase) | | | | | | | | | | | | |
| Results of | Shock | Presence/absence of | Present | | Present | Present | Present | Absence | Absence | Absence | Absence | Absence | |
| repetitive | absorbing | formation of shock | | | | | | | | | | | |
| one-point- | structure | absorbing structure | | | | | | | | | | | |
| impact test | | Number of impacts | 3 | 2 | 5 | 2 | 2 | 2 | — | — | — | — | — |
| | | required for the | | | | | | | | | | | |
| | | formation | | | | | | | | | | | |
| | Number of | Upswing height | 9 | — | 10 | — | — | — | 1 | 1 | 2 | 2 | — |
| | impacts | 700 mm | | | | | | | | | | | |
| | required for | Upswing height | — | 6 | — | 16 | 7 | 5 | — | 1 | 1 | 1 | 8 |
| | the | 1,400 mm | | | | | | | | | | | |
| | penetration | | | | | | | | | | | | |
| | on | | | | | | | | | | | | |
| | transparent | | | | | | | | | | | | |
| | surface | | | | | | | | | | | | |

Sample No. 1 of the example has a configuration in which six glass layers made of an alkali-free glass sheet of an OA-10 composition with a thickness of 0.7 mm and five resin layers made of a PVB resin with a thickness of 0.8 mm are laminated alternately. When Sample No. 1 was subjected to a repetitive one-point-impact test at an upswing height of 700 mm, a tip H of a impact object did not penetrate all the layers of the laminated glass until the eighth shock, and penetrated then at the ninth shock. In the case of Sample No. 1, after the third impact, the formation of the shock absorbing structure was recognized. The shock absorbing structure is viscoelastic and is formed of a mixture of glass powders and a PVB resin. In order to investigate the properties of the mixture, an organic component in the shock absorbing structure was removed using a solvent of a PVB resin (a solvent containing natural citrus oil and a vegetal surfactant) and the remaining glass powders were identified using SEM, a stereoscopic microscope, or the like. As a result, the mixture (shock absorbing structure) contained 20 or more glass powders per 30 mm³ of volume. Further, the size of the glass powders was 0.1 to 0.2 mm. It was confirmed that the glass powders were mixed with the PVB resin to form a shock absorbing structure, whereby shock can be absorbed efficiently. Further, from fluorescent X-ray analysis or wet-type chemical analysis, it was confirmed that the glass powders have an OA-10 composition. Further, the volume of the mixture (shock absorbing structure) was measured to be 10 mm³. Further, Sample No. 1 of this example was further evaluated by doubling the upswing height to 1,400 mm. As a result, Sample No. 1 was not penetrated after the fifth impact even when the upswing height was doubled, and hence, had sufficient durability.

In Sample No. 2 of this example, eight glass layers and seven resin layers were laminated alternately using the glass layers and resin layers (the resin layers are formed of an ethylene vinyl acetate copolymer (EVA)) similar to those of No. 1. Sample No. 2 was subjected to a repetitive one-point-impact test at an upswing height of 700 mm. As a result, in Sample No. 2, a tip H of a impact object did not penetrate all the layers of the laminated glass even after the ninth impact and penetrated them at the tenth impact. In Sample No. 2, the formation of the shock absorbing structure was recognized after the fifth impact. FIGS. 4 and 5 show an enlarged picture photographed from a side of a glass transparent surface on which the head of an impact object bumped against the laminated glass after being supplied with the tenth impact. FIG. 5 is obtained by negative/positive inversion of FIG. 4. In the picture, it is noted that a minute fracture surface T is formed radially from the center of the sample, and a shock absorbing structure M is formed at the center. The EVA resin in the shock absorbing structure M was removed by ignition heating instead of dissolving into a solvent, and the contained glass powders were observed by the procedure similar to that of Sample No. 1. As a result, the number of the glass powders contained in the shock absorbing structure M is 50 or more per 30 mm³ of volume of the shock absorbing structure M. Further, the size of the glass powders was 0.05 to 0.3 mm, and the volume of the shock absorbing structure M was 20 mm. It was confirmed that, due to the presence of the shock absorbing structure M, the shock force was absorbed efficiently.

Sample No. 2 of this example was further evaluated by doubling the upswing height to 1,400 mm in the same way as in Sample No. 1. As a result, it was found that Sample No. 2 was not penetrated after the 15th impact even when the upswing height was doubled and had high durability. Further, it was confirmed that the shock absorbing structure M was formed at a site in which two or more glass layers were broken after the second impact. The volume of the shock absorbing structure M was 20 mm³ or more.

In Sample No. 3 of this example, eight glass layers and seven resin layers were laminated alternately using the glass layers and the resin layers similar to those of No. 1. Sample No. 3 was subjected to a repetitive one-point-impact test at an upswing height of 1,900 mm. As a result, all the layers of the laminated glass were not penetrated even after the sixth impact, and penetrated at the seventh impact. Further, in Sample No. 3, at the second impact, a shock absorbing structure was formed in a site in which two or more glass layers were broken.

In Sample No. 4 of this example, six glass layers and five resin layers were laminated alternately using the glass layers similar to those of No. 1 and the resin layers made of the same material as that of No. 1 with a thickness set to be 0.4 mm. Sample No. 4 was subjected to a repetitive one-point-impact test at an upswing height of 1,400 mm. As a result, all the layers of the laminated glass were not penetrated even after the fourth impact and penetrated at the fifth impact. Further, in Sample No. 4, a shock absorbing structure was formed at a site in which two or more glass layers were broken at a time of the second impact.

As a comparative example, Sample No. 101 was subjected to the same repetitive one-point-impact test. The sample is a simple sheet glass, instead of a laminated glass with resin layers and the like interposed, which is composed of a glass material made of soda-lime glass with a thickness of 3.0 mm used in ordinary constructions. Sample No. 101 was evaluated in the same way as in the example of the present invention. As a result, Sample No. 101 was penetrated (broken) completely at the first impact even under an upswing height condition of 700 mm. Needless to say, a shock absorbing structure was not formed because there were no resin layers and the like.

Further, Sample No. 102 that is a comparative example is a general laminated glass in which a PVB layer with a thickness of 1.5 mm is interposed between two soda-lime glasses with a thickness of 3.0 mm. Sample No. 102 was subjected to a repetitive one-point-impact test at an upswing height of 700 mm. As a result, Sample No. 102 was not able to withstand even the first impact, and a through-hole was formed easily. The penetrated portion was inspected, but the formation of a shock absorbing structure was not seen. Further, Sample No. 102 was evaluated under an upswing height condition of 1,400 mm. A through-hole was formed at the first impact as expected, and the formation of a shock absorbing structure was not seen.

Sample No. 103 that is a comparative example has a configuration in which a PVB layer with a thickness of 2.3 mm is interposed between two soda-lime glasses with a thickness of 3.0 mm. Sample No. 103 was subjected to a repetitive one-point-impact test at an upswing height of 700 mm. As a result, Sample No. 102 withstood the first impact, however a through-hole was formed by the second impact. A vicinity of the through-hole was observed, but the formation of a shock absorbing structure was not seen. Further, Sample No. 102 was evaluated under an upswing height condition of 1,400 mm. As a result, a through-hole was formed at the first impact, and the formation of a shock absorbing structure was not seen.

Sample No. 104 that is a comparative example has a configuration in which a PC layer with a thickness of 1.2 mm is interposed between two soda-lime glasses with a thickness of 3.0 mm. Sample No. 104 was subjected to a repetitive one-point-impact test at an upswing height of 700 mm. As a result, as the same as Sample No. 103, Sample No. 102 withstood the first impact, but a through-hole was formed by the second impact. The formation of a shock absorbing structure was not seen. Further, Sample No. 102 was evaluated under an upswing height condition of 1,400 mm. As a result, a through-hole was formed at the first impact, and the formation of a shock absorbing structure was not seen as expected.

Sample No. 105 that is a comparative example has a configuration in which a PVB layer with a thickness of 2.3 mm is interposed between tempered glass with a thickness of 8 mm and a soda-lime glass with a thickness of 3 mm. Sample No. 105 was subjected to a repetitive one-point-impact test at an upswing height of 1,400 mm. As a result, Sample No. 105 withstood the seventh impact, and a through-hole was formed at the eighth impact. This shows that Sample No. 105 is inferior to Sample No. 0.2 of the example in characteristics. When the vicinity of the through-hole was observed, the formation of a shock absorbing structure was not seen.

As described above, the laminated glass of the present invention has high durability with respect to repeated impacts at the one-point. Therefore, the laminated glass of the present invention has excellent performance as a lighting window material having high penetration resistance to be mounted on a window material for housing of a construction or the like.

### BRIEF DESCRIPTION OF THE DRAWINGS

FIG. 1 is a partial cross-sectional view of a laminated glass of the present invention.

FIG. 2 is a perspective view of a window material to which the laminated glass of the present invention is applied.

FIG. 3 is a conceptual view of a device for conducting a repetitive one-point-impact test: (A) is a front view; and (B) is a side view.

FIG. 4 is an enlarged picture of a glass surface in Example 2 in a repetitive one-point-impact test of the laminated glass of the present invention.

FIG. 5 is a negative/positive inverted image of the enlarged picture of the glass surface in Example 2 in the repetitive one-point-impact test of the laminated glass of the present invention.

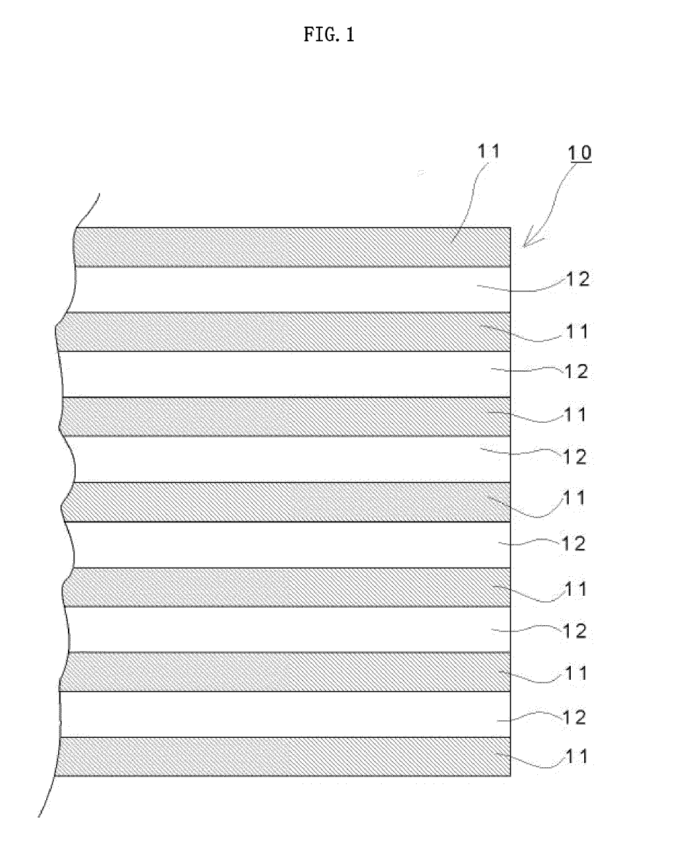

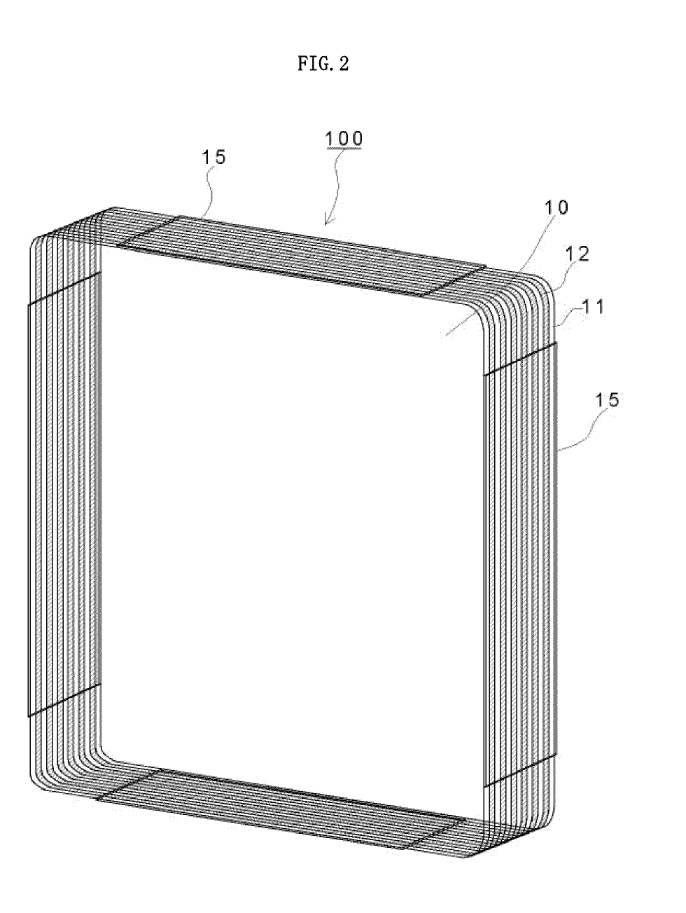

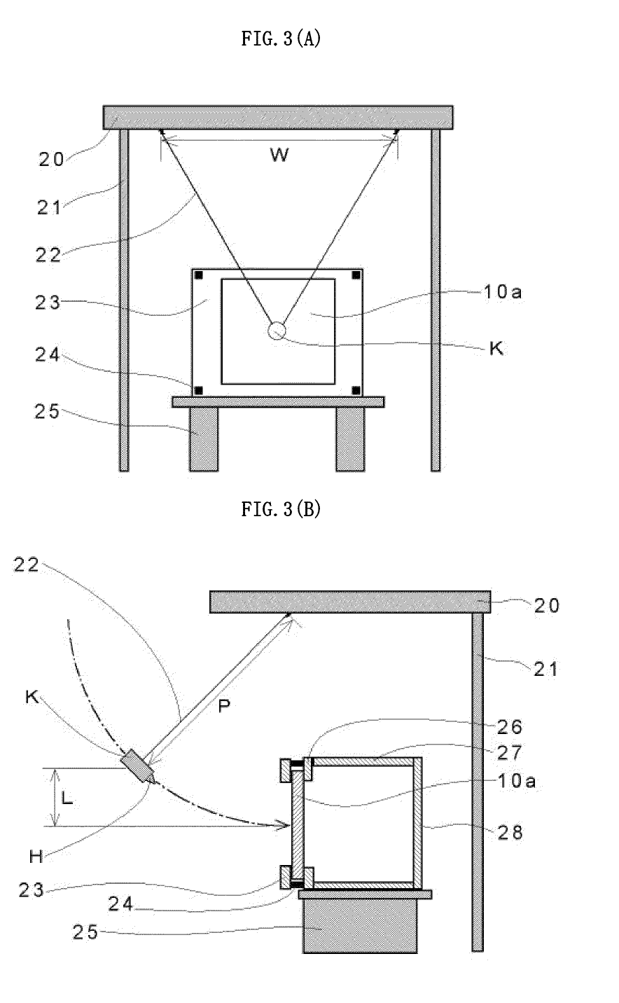

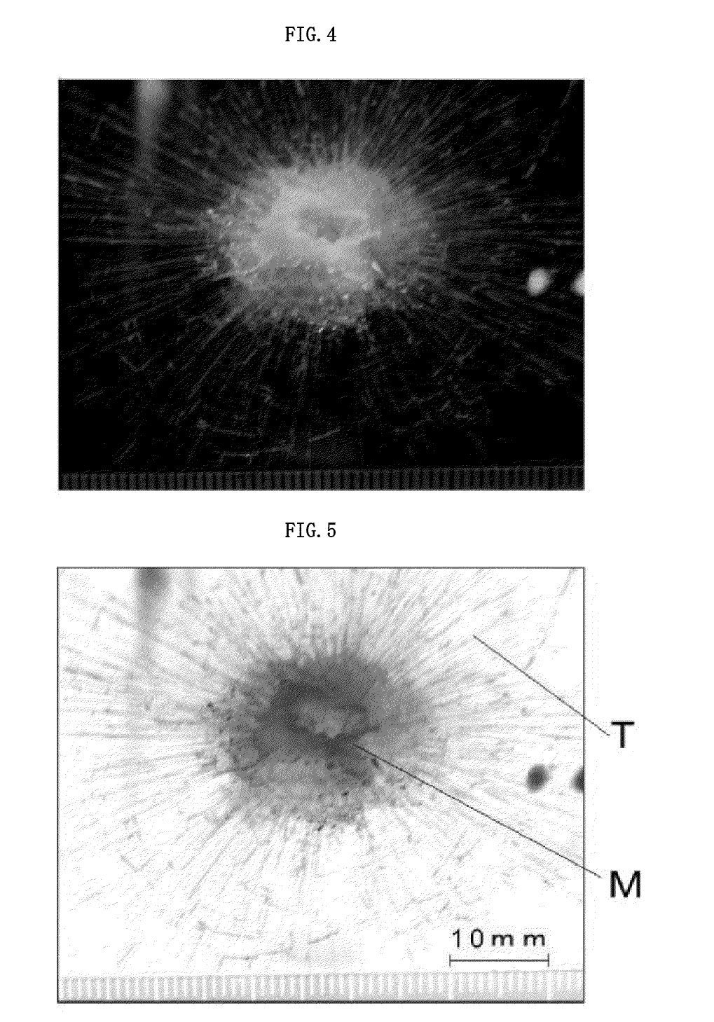

### DESCRIPTION OF SYMBOLS

10, 10a laminated glass
11 glass layer (thin sheet glass)
12 resin layer
15 protective member
100 window member

1. A laminated glass, comprising glass layers and resin layers laminated with each other, wherein a lamination structure in which four or more layers including the glass layers with a thickness of 1 mm or less and the resin layers with a thickness of 1 mm or less are laminated alternately, and a ratio of a thickness of the resin layer adjacent to the glass layer in the lamination structure with respect to a thickness of the glass layer is in a range of 0.1 to 2.0.

2. The laminated glass according to claim 1, wherein at least one of front and back transparent surfaces is formed of the glass layer of the lamination structure.

3. The laminated glass according to claim 1, wherein a base material resin of the resin layer is a thermoplastic resin.

4. A window material, wherein a protective member is placed at at least one of an end surface and a periphery of the front and back transparent surfaces of the laminated glass according to claim 1.

5. The window material according to claim 4, wherein the protective member is a member in one form selected from a plate shape, a net shape, a film shape, a paste shape, a cloth shape, a particle shape, an annular shape, and a band shape.

6. A wall surface structure with a window, wherein the window material according to claim 4 is constructed as a lighting window or a monitoring window.

7. The laminated glass according to claim 2, wherein a base material resin of the resin layer is a thermoplastic resin.

8. A window material, wherein a protective member is placed at least one of an end surface and a periphery of the front and back transparent surfaces of the laminated glass according to claim 2.

9. A window material, wherein a protective member is placed at least one of an end surface and a periphery of the front and back transparent surfaces of the laminated glass according to claim 3.

10. A window material, wherein a protective member is placed at least one of an end surface and a periphery of the front and back transparent surfaces of the laminated glass according to claim 7.

11. The window material according to claim 8, wherein the protective member is a member in one form selected from a plate shape, a net shape, a film shape, a paste shape, a cloth shape, a particle shape, an annular shape, and a band shape.

12. The window material according to claim 9, wherein the protective member is a member in one form selected from a plate shape, a net shape, a film shape, a paste shape, a cloth shape, a particle shape, an annular shape, and a band shape.

13. The window material according to claim 10, wherein the protective member is a member in one form selected from a plate shape, a net shape, a film shape, a paste shape, a cloth shape, a particle shape, an annular shape, and a band shape.

14. A wall surface structure with a window, wherein the window material according to claim 5 is constructed as a lighting window or a monitoring window.

15. A wall surface structure with a window, wherein the window material according to claim 8 is constructed as a lighting window or a monitoring window.

16. A wall surface structure with a window, wherein the window material according to claim 9 is constructed as a lighting window or a monitoring window.

17. A wall surface structure with a window, wherein the window material according to claim 10 is constructed as a lighting window or a monitoring window.

18. A wall surface structure with a window, wherein the window material according to claim 11 is constructed as a lighting window or a monitoring window.

19. A wall surface structure with a window, wherein the window material according to claim 12 is constructed as a lighting window or a monitoring window.

20. A wall surface structure with a window, wherein the window material according to claim 13 is constructed as a lighting window or a monitoring window.
